(19) United States
(12) Patent Application Publication
(10) Pub. No.: US 2025/0303979 A1
(43) Pub. Date: Oct. 2, 2025

(54) INTERIOR SYSTEM FOR A MOTOR VEHICLE

(71) Applicant: Ford Global Technologies, LLC, Dearborn, MI (US)

(72) Inventors: Simon Eberhard, Cologne (DE); Nazim Djoudi, Cologne (DE)

(73) Assignee: Ford Global Technologies, LLC, Dearborn, MI (US)

(21) Appl. No.: 19/055,089

(22) Filed: Feb. 17, 2025

(30) Foreign Application Priority Data
Mar. 27, 2024 (DE) 102024108700.5

(51) Int. Cl. B60R 13/02

(52) U.S. Cl. CPC B60R 13/0262; B60R 2013/0287

(57) ABSTRACT

An interior system for a motor vehicle has an interior structure at least partially adjacent to a vehicle interior with at least one module base, which has a base trim with a base connection arrangement arranged thereon which is associated with a transmission system of the motor vehicle, and the interior system also has at least one function module which has a module housing with a module connection arrangement arranged thereon, and which can be mechanically coupled to a module base in a coupling position such that the base and module connection arrangements are coupled in a transmitting manner and the base trim is at least partially covered relative to the vehicle interior by the module housing. In a locking position, a retention mechanism prevents decoupling of the function module from the module base.

### CROSS-REFERENCE TO RELATED APPLICATION

This application claims foreign priority benefits under 35 U.S.C. § 119(a)-(d) to German Application No. 102024108700.5 filed Mar. 27, 2024, which is hereby incorporated by reference in its entirety.

### FIELD OF THE DISCLOSURE

The present disclosure generally relates to an interior system for a motor vehicle, and more particularly relates to a flexible configuration of functional components in a vehicle interior of a motor vehicle.

### BACKGROUND OF THE DISCLOSURE

Modern motor vehicles such as cars or trucks commonly have various functional components in the interior, which, for example, offer air conditioning, multimedia functions, connection options for mobile devices or serve as storage. Such components are usually integrated into the interior systems (for example instrument panel, trim, center console, etc.) and embedded in them. As a result, a specific configuration of the components is specified for a given vehicle. The customization or adaptation to technological developments, such as changing connector types, media types, screen specifications, etc. can be desirable. The location of a particular connection function, memory function or multimedia function is also typically geographically fixed in the interior. In addition, the electrical architecture is generally unique for each vehicle model in order to match the connectivity strategy of the program defined before the start of production.

It would be desirable to provide for the provision of functional components in a vehicle interior that offers enhanced flexible configurations.

### SUMMARY OF THE DISCLOSURE

According to a first aspect of the present disclosure, an interior system for a motor vehicle has an interior structure at least partially adjacent to a vehicle interior having at least one module base, a base trim on the at least one module base, and a base connection arrangement arranged on the base trim. The base trim is associated with a transmission system of the motor vehicle. At least one function module has a module housing. A module connection arrangement is arranged on the module housing and configured to be mechanically coupled to the at least one module base in a coupling position such that the base connection arrangement and module connection arrangement are coupled in a transmitting manner and the base trim is at least partially covered by the module housing relative to the vehicle interior. When in a locking position, a retention mechanism prevents decoupling of the at least one function module from the at least one module base.

Embodiments of the first aspect of the present disclosure can include any one or a combination of the following features:
the at least one function module comprises a plurality of different function modules, each configured to be coupled to a module base;
the interior structure has a plurality of module bases, and wherein the at least one function module is configured to be coupled to different module bases;
at least one of the base connection arrangement and the module connection arrangement has a data connection unit for at least one of a data transmission and a power connection unit for power transmission;
the at least one function module has at least one of an input interface and an output interface for a user, a read functionality for a mobile data carrier, an external interface, a charging socket and/or a wireless communication interface;
the at least one module base and the at least one function module have mutually interacting guide structures by which the at least one function module can be moved along a guide axis to the coupling position on the module base;
at least one of the base connection arrangement and the module connection arrangement is arranged on a surface running parallel to the guide axis;
the retention mechanism has an elastically deflectable latching element, which engages in a form-fitting manner in a latching recess in the locking position;
the module housing has a main section and a foot section, on which the module connection arrangement is arranged, projecting at an angle to the guide axis, and wherein the base trim has a retention section which forms a form fit with the foot section transversely to the guide axis; and
the module housing and the base trim have contact surfaces which are adjacent to each other in the coupling position and run at least partially parallel to a contact plane which runs obliquely to the guide axis.

According to a second aspect of the present disclosure, an interior system for a motor vehicle has an interior structure at least partially adjacent to a vehicle interior having a plurality of module bases and a base trim on each of the plurality of module bases. A base connection arrangement is arranged on the base trim. The base trim is associated with a transmission system of the motor vehicle. A plurality of different function modules, each having a module housing, is configured to be coupled to a module base. A module connection arrangement is arranged on the module housing and configured to be mechanically coupled to the module base in a coupling position such that the base connection arrangement and module connection arrangement are coupled in a transmitting manner and the base trim is at least partially covered by the module housing relative to the vehicle interior. When in a locking position, a retention mechanism prevents decoupling of the function module from the module base.

Embodiments of the second aspect of the present disclosure can include any one or a combination of the following features:
at least one of the base connection arrangement and the module connection arrangement has a data connection unit for at least one of a data transmission and a power connection unit for power transmission;
the plurality of different function modules each has at least one of an input interface and an output interface for a user, a read functionality for a mobile data carrier, an external interface, a charging socket and/or a wireless communication interface;
each of the plurality of module bases and the plurality of function modules have mutually interacting guide structures by which the function module can be moved along a guide axis to the coupling position on the module base;
at least one of the base connection arrangement and the module connection arrangement is arranged on a surface running parallel to the guide axis;
the retention mechanism has an elastically deflectable latching element, which engages in a form-fitting manner in a latching recess in the locking position;
the module housing has a main section and a foot section, on which the module connection arrangement is arranged, projecting at an angle to the guide axis, and wherein the base trim has a retention section which forms a form fit with the foot section transversely to the guide axis; and
each of the plurality of module housings and the plurality of base trims have contact surfaces which are adjacent to each other in the coupling position and run at least partially parallel to a contact plane which runs obliquely to the guide axis.

According to a third aspect of the present disclosure, a motor vehicle has a transmission system, a vehicle interior and an interior system for a motor vehicle. The interior structure is at least partially adjacent to a vehicle interior having at least one module base, a base trim on the at least one module base, and a base connection arrangement arranged on the base trim. The base trim is associated with the transmission system of the motor vehicle. At least one function module has a module housing. A module connection arrangement is arranged on the module housing and configured to be mechanically coupled to the at least one module base in a coupling position such that the base connection arrangement and module connection arrangement are coupled in a transmitting manner and the base trim is at least partially covered by the module housing relative to the vehicle interior. When in a locking position, a retention mechanism prevents decoupling of the at least one function module from the at least one module base.

Embodiments of the third aspect of the present disclosure can include any one or a combination of the following features:
the at lease one function module comprises a plurality of different function modules, each configured to be coupled to a module base; and
the interior structure has a plurality of module bases, and wherein the at least one function module is configured to be coupled to different module bases.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic plan view of a motor vehicle with an interior system according to one embodiment;

FIG. 2 is a perspective representation of a first embodiment of a function module and a module base of the interior system shown in FIG. 1;

FIG. 3 is a side view of the function module and the module base shown in FIG. 2;

FIG. 4 is a perspective representation of a detail of the function module shown in FIG. 2;

FIG. 5 is a perspective representation of a detail of the module base shown in FIG. 2;

FIG. 6 is a bottom view of a foot section of a function module having power and data connection according to one embodiment;

FIG. 7 is a bottom view of a foot section of a function module having power connectors according to another embodiment;

FIG. 8 is a bottom view of a passenger foot section of a function module according to a further embodiment;

FIG. 9 is a perspective representation of a part of an interior structure of the interior system with the module base shown in FIG. 2;

FIG. 10 is a perspective representation according to FIG. 9 with a function module coupled to the module base, according to one example;

FIG. 11 is a perspective representation according to FIG. 9 with a function module coupled to the module base, according to another example;

FIG. 12 is a perspective representation according to FIG. 9 with a function module coupled to the module base, according to a further example;

FIG. 13 is a perspective representation according to FIG. 9 with a function module coupled to the module base, according to yet a further example;

FIG. 14 is a perspective representation according to FIG. 9 with a function module coupled to the module base, according to yet a further example;

FIG. 15 is a perspective representation of another part of the interior structure of the interior system with the module base shown in FIG. 2;

FIG. 16 is a perspective representation according to FIG. 15 with a function module coupled to the module base, according to one example;

FIG. 17 is a perspective representation according to FIG. 15 with a function module coupled to the module base, according to another example;

FIG. 18 is a perspective representation according to FIG. 15 with a function module coupled to the module base, according to a further example;

FIG. 19 is a perspective representation according to FIG. 15 with a function module coupled to the module base, according to yet a further example; and

FIG. 20 is a perspective representation according to FIG. 15 with a function module coupled to the module base, according to yet a further example.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

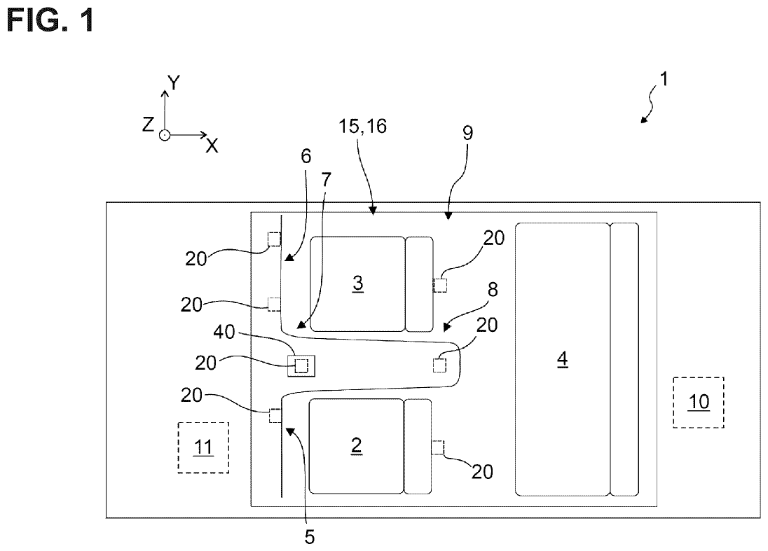

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an interior system for a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, mechanism that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present application may refer to amounts and numbers. Unless expressly stated otherwise, such amounts and numbers should not be considered limiting but should be considered examples of the possible amounts or numbers in the context of the present application. In this context, the present application might also use the phrase “a plurality of” in order to refer to an amount or number. In this context, the phrase “a plurality of” should be in any number greater than one, e.g., two, three, four, five, etc. The terms “around”, “approximately”, “near”, etc. mean plus or minus 5% of the value specified.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Equivalent parts are denoted by the same reference signs in the figures and are therefore generally only described once.

Referring to FIG. 1, a schematic plan view of a motor vehicle 1 is illustrated in one example configured as a passenger car. For better orientation, a longitudinal axis X pointing towards the rear of the vehicle, a transverse axis Y and an upward-pointing vertical axis Z are drawn. The motor vehicle 1 has a driver's seat 2, a passenger seat 3 and a back seat 4. Also illustrated are a driver's instrument panel 5, a passenger instrument panel 6, a front center tunnel section 7 and a rear center tunnel section 8. The elements mentioned belong in part, at least in part, to an interior structure 16 of an interior system 15 according to the disclosure. The interior structure 16, which may be at least partly formed by elements of an interior trim (without reference signs), at least partly bounds an interior space 9 of the motor vehicle 1. The interior system 15 also has a plurality of module bases 20. In FIG. 1, a module base 20 is arranged on the driver's instrument panel 5, two module bases 20 on the passenger instrument panel 6, one on the front center tunnel section 7, one module base 20 on the rear center tunnel section 8, and one module base 20 each on a backrest of the driver's seat 2 and the passenger seat 3. The arrangement of the module bases 20 shown is to be understood as an example, wherein it should be appreciated that other suitable locations can be chosen. As an example, a function module 40 is shown that is coupled to the module base 20 in the front center tunnel section 7.

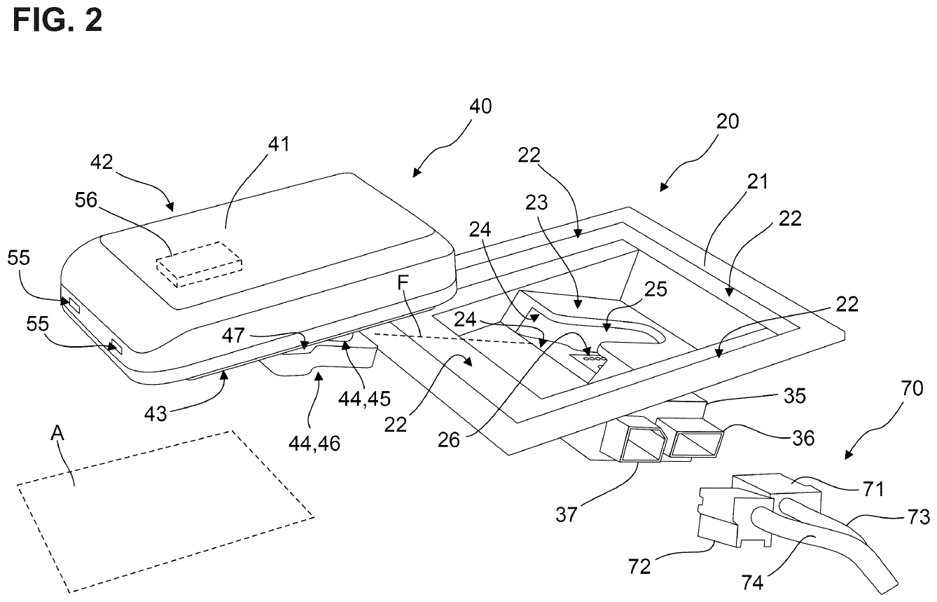

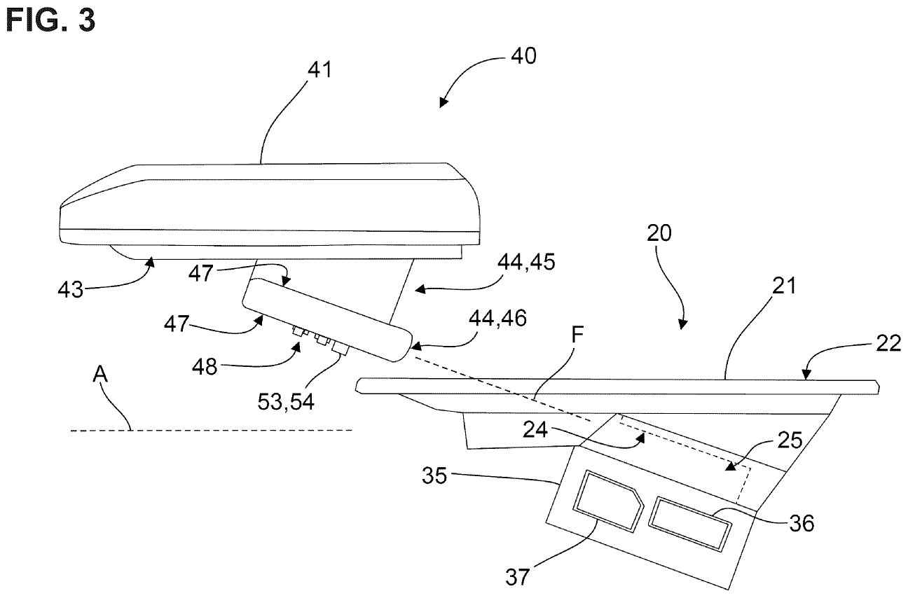

FIG. 2 shows a module base 20 and a function module 40 in a decoupled state in a perspective representation, while FIG. 3 shows a side view. The module base 20 has a base trim 21, which can be made, for example, of plastic or composite. The module base 20 has a plurality of base contact surfaces 22 that run parallel to a contact plane A. Furthermore, a retention section 23 can be recognized, which has guide structures in the form of base guide surfaces 24, which are oriented parallel to a guide axis F, and which also defines a recess 25, the function of which is explained below. In addition, a base connection arrangement 26 that is arranged in the area of the recess 25 is connected to a terminal block 35. The terminal block 35 has a power socket 36 and a data socket 37, to which a power plug 71 and a data plug 72 can be connected. The aforementioned power and data plugs 71, 72 are connected to a power cable 73 and a data cable 74 respectively and together with these form parts of a transmission system 70. Instead of a single transmission system 70, we could also speak of a data transmission system on the one hand and an energy transmission system on the other. By use of the transmission system 70, the base connection arrangement 26 is connected on the one hand to a vehicle battery 10 and on the other hand to a vehicle control system 11. In addition, it can be connected to base connection arrangements 26 of other module bases 20 for data transmission.

The function module 40 has a module housing 41, which, for example, may be made of plastic or a composite material, in an ideal design with a coating or a cover corresponding to the base trim 21. Various electrical components may be arranged within the module housing 41, which are not shown here. On the outside of the module housing 41 are arranged two external interfaces 55 (for example USB ports). In addition, within the module housing 41, more precisely in a main section 42 of it, a wireless communication interface 56 is arranged, for example a Bluetooth® interface. On the main section of the module housing 41, module contact surfaces 43 are formed, which correspond to the base contact surfaces 22 and are also oriented parallel to the contact plane A. In addition, a foot section 44 protrudes from the main section 42, which in turn has a connecting section 45, which is immediately adjacent to the main section 42, and an adjoining flange section 46, which protrudes to opposite sides from the connecting section 45. On the flange section 46, guide structures in the form of modular guide surfaces 47 are formed, which also run parallel to the guide axis F and match the base guide surfaces 24 in terms of shape and geometry. The flange section 46 also has a module connection arrangement 48. As can be seen particularly well in FIG. 3, the contact plane A and the guide axis F run at an angle to each other, in this example at an angle of approximately 20°. In order to couple the function module 40 to the module base 20, the function module 40 is brought parallel to the guide axis, wherein the aforementioned guide surfaces 24, 47 interact with each other, defining the guide axis F. The foot section 44 is inserted into the aforementioned recess 25. Finally, the function module 20 reaches a coupling position in which the base connection arrangement 26 and the module connection arrangement 48 are coupled in a transmitting manner which, in this case, are in electrically conductive contact. The coupling position can be defined by the fact that the retention section 23 forms a stop for the foot section 44 in the direction of the guide axis F. On the other hand, the coupling position is defined by a retention mechanism 53, which is formed by an elastically deflectable latching element 54 on the foot section 44 and a corresponding latching recess 31 in the area of the base connection arrangement 26.

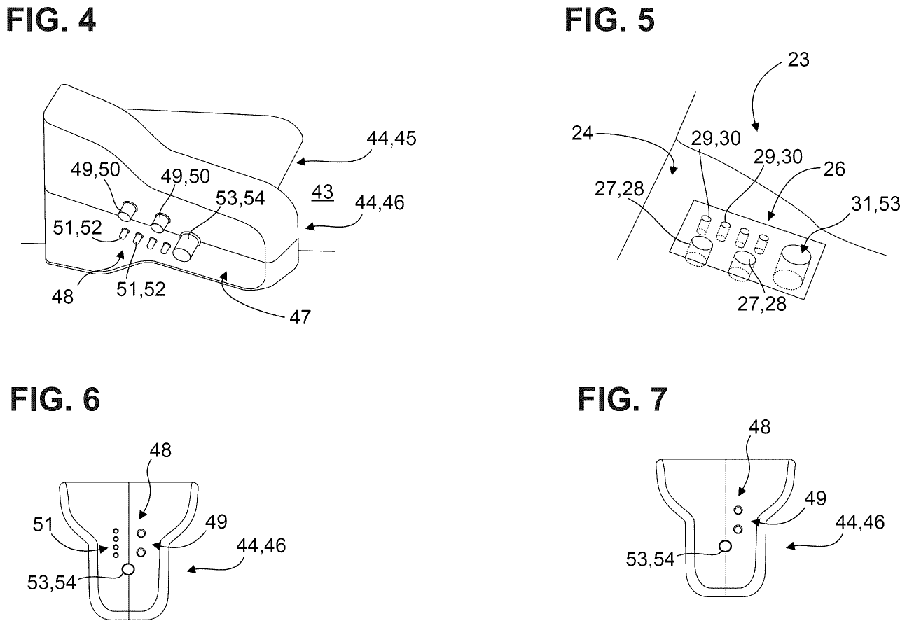

As can be seen in particular in FIGS. 4 and 6, the module connection arrangement 48 has on the one hand a power connection unit 49 with power contacts 50, and on the other hand a data connection unit 51 with data contacts 52. Accordingly, the base connection arrangement 26 has a power connection unit 27 with power contacts 28 and a data connection unit 29 with data contacts 30. The power contacts 28 are connected to the power socket 36, while the data contacts 30 are connected to the data socket 37. The contacts 50, 51 of the module connection arrangement 48 protrude relative to the foot section 46, but can be elastically deflected so that they can be recessed into the module housing 41. On the other hand, the contacts 28, 30 of the base connection arrangement 26 are in the form of recesses into which the contacts 50, 51 of the module connection arrangement 48 can engage when the function module 40 has reached the coupling position.

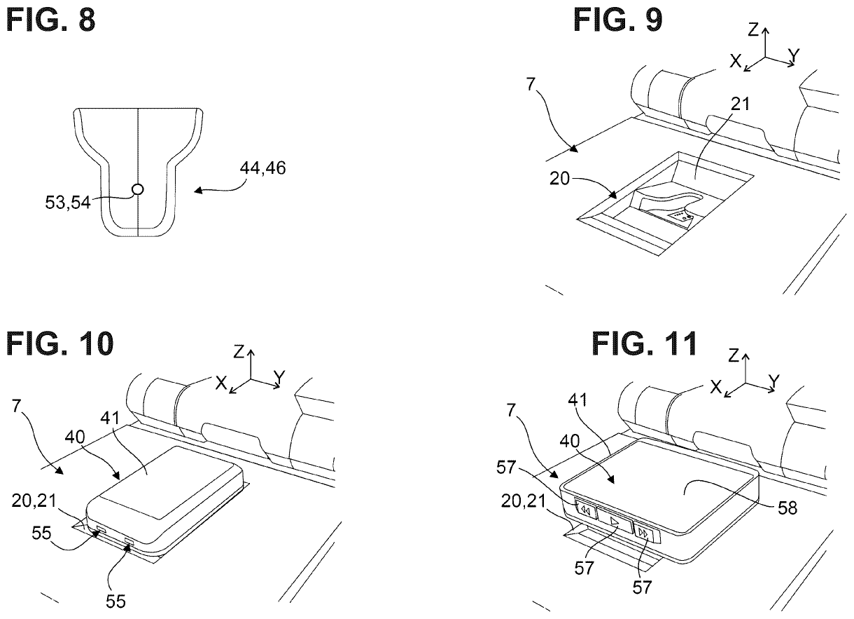

While FIG. 6 shows the foot section 44 of the function module 40 from FIGS. 2 and 3, FIG. 7 shows a corresponding representation of an alternative embodiment for a function module 40 which does not require a data connection. Accordingly, the data connection unit 51 is omitted and only the power connection unit 49 is present. FIG. 8 is a representation of a foot section 44 for a completely passive function module 40, which also requires no power supply, so that the entire module connection arrangement 48 is omitted.

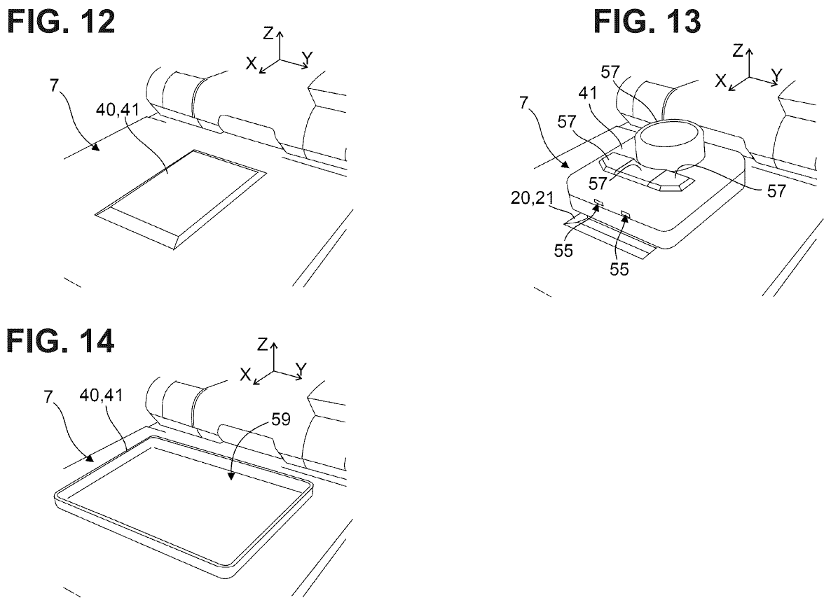

FIG. 9 shows a perspective representation of the front center tunnel section 7, in the surface of which the base trim 21 of the module base 20 is integrated. FIGS. 10-15 show views according to FIG. 9, wherein, however, a respective function module 40 is connected to the module base 20 in the coupling position. The base trim 21 is fully or partially covered relative to the interior 9 by the module housing 41. In particular, both connection arrangements 26, 48 are completely concealed. FIG. 10 shows the function module 40 already described with reference to FIGS. 2 and 3. FIG. 11 shows a function module 40 with a read functionality for a data carrier, in this example for a music cassette that is not shown. A lid 58 is arranged on the module housing 41, which is shown here in a closed state. In addition, a plurality of control elements 57 are provided on the module housing 41, which form an input interface for a user. The analog data read from the music cassette can be digitally converted in the function module 41 and then transmitted via the data connection units 29, 51. FIG. 12 shows an example of a purely passive function module 40 in the form of a cover module. This completely covers the base trim 21. It has a flat profile that protrudes as little as possible from the adjacent areas of the front center tunnel section 7. FIG. 13 shows a function module that in addition to two external interfaces 55 has a plurality of control elements 57 as input interfaces for a user. By use of these control elements 57, which are shown here as buttons and rotary controls, functions of an infotainment system can be controlled for example. FIG. 14 shows a function module 40 in the form of a storage module, which defines a storage space 59. Various items can be stored in this storage space 59. Normally, a design as a passive function module 40 is sufficient, but it would also be conceivable to integrate an active function, such as a wireless communication interface 52.

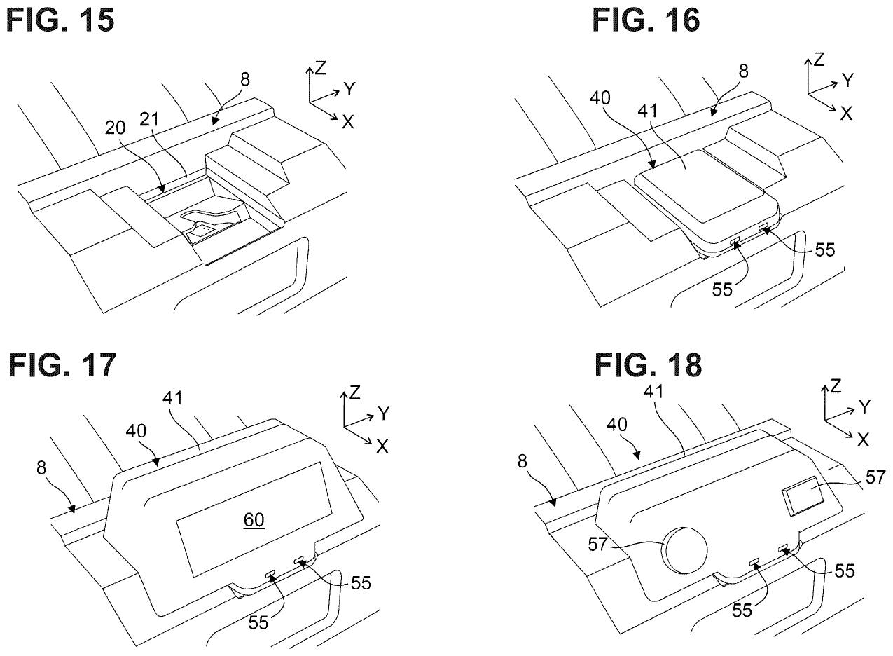

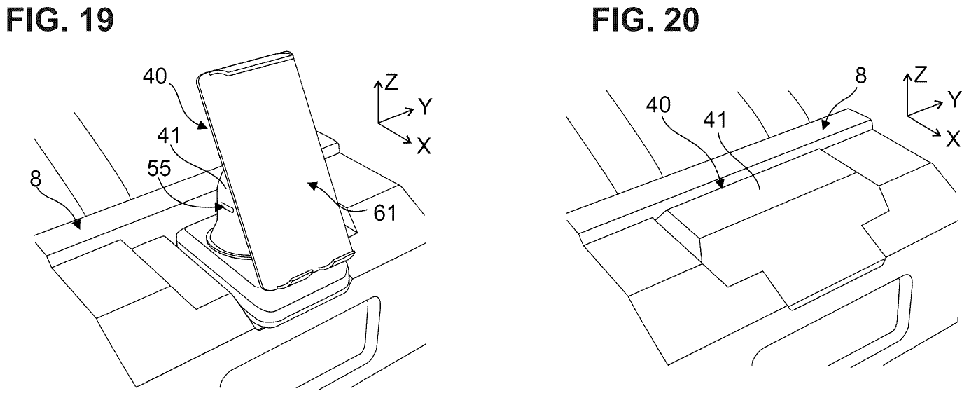

FIG. 15 shows a perspective representation of the rear center tunnel section 8, in the surface of which the base trim 21 of the module base 20 is integrated. FIGS. 16-20 each show views according to FIG. 15, wherein a function module 40 is connected to the module base 20 in the coupling position, wherein the base trim 21 is at least partially covered relative to the interior 9 by the module housing 41. FIG. 16 shows the function module 40 already described with reference to FIGS. 2 and 3. FIG. 17 shows a function module 40 with two external interfaces 55 and a touchscreen 60, which simultaneously represents an input interface and an output interface. FIG. 18 shows a simplified, smaller and cheaper version compared to FIG. 17, which has only two input elements 53 in the form of a rotary control and a button. FIG. 19 shows a function module 40 that has a holder 61 for a smartphone in addition to an external interface 55. The smartphone can be connected to an infotainment system via the external interface 55 and can also be charged. A wireless communication interface 56 can also be integrated into the function module. FIG. 20 again shows a function module 40 of a passive form, which only serves to cover the base trim 21.

The disclosure provides an interior system for a motor vehicle. Here the term “motor vehicle” in the narrower sense may refer to a road vehicle, i.e. a vehicle suitable and registered for road traffic. In particular, the motor vehicle can be a car, a truck or a bus. There are no restrictions on the propulsion of the motor vehicle; for example, the motor vehicle can be powered by an internal combustion engine that uses gasoline, diesel, LPG, hydrogen or another gas as fuel. Alternatively or additionally, an electric motor can be provided, which can be supplied with energy by a battery unit and/or a fuel cell, for example. Preferably, the motor vehicle has at least two axles, each with two wheels, but deviations from this are also conceivable. The term “interior system” refers to the fact that the system, which has at least two components, is intended for the interior of the motor vehicle and is associated with it. The interior can also be referred to as the passenger cell and is the area intended for occupation by persons inside the motor vehicle. With regard to the interior system, this may of course also include a front and/or rear area of the motor vehicle with a frunk and/or a trunk. The term “frunk” is made up of “front” and “trunk”. Frunk therefore refers to the trunk under the hood, under which there is space for an additional trunk in many electric cars.

The interior system has an interior structure that is at least partially adjacent to a vehicle interior. When assembled, the interior structure is part of a vehicle body, which in particular can form the sprung mass. The interior structure, which can also be referred to as an interior arrangement, can be associated with a body of the motor vehicle in particular. It is at least partly adjacent to the vehicle interior; it can also be said that it at least partly bounds the vehicle interior. The interior structure can include, in particular, an instrument panel, a center console, trim on the vehicle walls or doors, but also, for example, parts of vehicle seats, for example armrests in the front and in the rear. In a broader sense, the interior structure may also be referred to as an interior trim structure, although it may have elements which, at least not in the strict sense, are part of the interior trim of the motor vehicle.

The interior structure has at least one module base, which has a base trim with a base connection arrangement attached to it, which is associated with a transmission system of the motor vehicle. The module base forms a base for a function module that will be explained below. It is part of the interior structure and therefore preferably part of the vehicle body, especially the bodywork. Unless distortion of the shape occurs, the module base is normally intended to be permanently installed in a fixed position throughout the life of the motor vehicle. The base trim can be seen as part of the interior trim of the motor vehicle. It can be directly adjacent to the vehicle interior in whole or in part. Accordingly, it can have a usable surface at least in some areas, particularly a surface that an occupant of the motor vehicle can see and touch. Typical materials for the base trim are for example plastic or composites. At least in some areas, the base trim can have a coating or overlay that serves to create an advantageous look and/or feel. A base connection arrangement, which is associated with a transmission system of the motor vehicle, is arranged on the base trim. The transmission system can also be described as a distribution system, at least in some embodiments. Accordingly, it can have conductors or wires that are used for transmission and that can be coupled to the base connection arrangement for transmission. As will be explained below, the transmission system is primarily used for power and/or signal transmission. The base connection arrangement allows connection to the transmission system. At least some of the aforementioned conductors or wires can be regarded as part of the interior structure. Depending on how you look at it, it can also be said that the base connection arrangement belongs to the transmission system, i.e. is part of it.

Furthermore, the interior system has at least one function module, which has a module housing with a module connection arrangement arranged thereon. The function module can have different functions, some of which will be discussed below. The module housing preferably closes off the function module from the outside and gives it mechanical stability. However, the term “housing” is not to be interpreted as meaning that the module housing must necessarily be closed. It can protect internal elements of the function module from dirt, distortion, moisture and/or other influences. The module connection arrangement is located on the module housing, wherein the position thereof or the position of individual components of the module connection arrangement on the module housing is preferably fixed, possibly except for limited movability with a degree of freedom.

The respective function module can be mechanically coupled to a module base in a coupling position in such a way that the connection arrangements are coupled in a transmitting manner and the base trim is at least partially covered by the module housing relative to the vehicle interior, wherein a retention mechanism in a locking position prevents the function module from being decoupled from the module base. The coupling position refers to a position of the function module relative to the module base. In this position, there is a mechanical coupling between the function module and the module base. This preferably includes a form fit between the function module and the module base, which can be implemented directly or, if necessary, indirectly via an intermediate element. The aforementioned form fit is ideally designed in such a way that the function module and module base can be non-destructively separated from each other. The mechanical coupling can also involve a force fit. Due to the mechanical coupling, the function module is preferably fixed relative to the module base, apart from a negligible displaceability, which also determines the coupling position. In any case, in the coupling position, the base connection arrangement and the module connection arrangement are coupled in a transmitting manner, such that they are coupled in such a way that a transfer from one connection arrangement to the other is possible. This can refer to a transfer from the base connection arrangement to the module connection arrangement and/or vice versa. In any case, the function module is coupled to the transmission system. It is therefore connected to the relevant infrastructure of the motor vehicle. This enables the function module to perform the intended function thereof, possibly also a plurality of functions.

In the coupling position, the base trim is at least partially covered by the module housing relative to the vehicle interior. This means that at least part of the base trim is no longer freely accessible from the vehicle interior. Preferably, at least part of the base trim is no longer visible. It is possible that there is still a gap between the module housing and the base trim, which, however, preferably has a width of no more than 5 mm, no more than 2 mm or no more than 1 mm. This means that an occupant cannot touch the covered area of the base trim. Preferably, the module housing rests at least in sections on the base trim. It is obvious that the base connection arrangement is preferably located in a covered part of the base trim. As a result, both connection arrangements are shielded from the vehicle interior to a certain extent. They are thus protected from mechanical distortion, fouling and other influences, at least to a certain extent. In addition, they are not visible to the occupant. Since the module housing covers at least part of the base trim in the manner described, it in turn forms part of the interior trim of the motor vehicle. Especially since the occupant does not see the connection arrangements, the function module is ideally perceived by them as an integral part of the motor vehicle.

In a locking position, the retention mechanism prevents the function module from being decoupled from the module base. This means that when the retention mechanism is in the locking position, it prevents the function module from being decoupled from the module base. The retention mechanism can be fully or partially integrated into the module base and/or into the function module. However, it can also be formed, at least in part, by another element. In particular, it can create a form fit, but if necessary also a force connection, either directly between the function module and the module base or indirectly, such as via at least one intermediate element. At least in the case of a form fit, in the locking position the retention mechanism would also prevent the function module from being brought into the coupling position. Therefore, the retention mechanism is preferably adjustable between the locking position and an unlocking position. When the retention mechanism is in the unlocking position, the function module can be decoupled from the module base. Of course, this refers to non-destructive decoupling, in particular tool-free decoupling.

The interior system according to the disclosure enables a flexible design in which a function module can be optionally integrated. In the coupled state, such as in the coupling position, the function module can be perceived as an integral part of the motor vehicle, wherein the module housing forms part of the interior trim, at least in the perception of an occupant. The function module is mechanically coupled to the module base in the coupling position and secured by the retention mechanism against unintentional or possibly unauthorized removal. Since the function module with the module housing at least partially covers the base trim, part of the module housing as well as at least part of the base cover is protected from mechanical influences, dirt, at least to a certain extent. As already mentioned above, this area is where the connection arrangements are preferably located, which helps to maintain the functionality.

The advantages of the modular design of the interior system can be increased by additional combination options. According to one embodiment, the interior system has a number of different function modules that can optionally be coupled to a module base. This means that the different function modules and the module base are matched to each other in such a way that one of the function modules can be selected and coupled to the module base. In this way, it is possible to optionally provide different function modules and thus different functions at one and the same location in the motor vehicle. It is also possible to replace a function module, not only in case of distortion, but also for example to provide a different function or, in the case of a similar function, to implement a different, in particular more modern, technical standard. It goes without saying that different functionalities can also be provided for the initial equipment of the motor vehicle depending on the customer's requirements.

Another embodiment, which can be combined in particular with the aforementioned embodiment, provides that the interior structure has a plurality of module bases, wherein at least one function module can optionally be coupled to different module bases. For example, one module base could be arranged on the instrument panel in the passenger area, while another module base is arranged on the center console, a third module base at the rear end of the center tunnel, a fourth module base on the backrest of the driver's seat or passenger seat, etc. This means that a module base can be selected for one and the same function module. Thus, it can be optionally decided where a certain function should be made accessible.

According to one design, at least one connection arrangement has a data connection unit for data transmission. Accordingly the transmission system is also set up for data transmission. The data connection unit may have one or more electrical contacts, which in the coupling position may be in electrically conductive contact with corresponding contacts of a data connection unit of the other connection arrangement. Although an electrically conductive contact is preferred, electrical signals can also be transmitted contactlessly, for example inductively and/or capacitively. Apart from electrical data transmission, however, another transmission principle can also be used. For example, optical transmission would be conceivable, with which light pulses from the transmission system are coupled into the function module via the base connection arrangement and the module connection arrangement. Of course, the reverse transmission path is also possible. The term “data transmission” here and in the following preferably refers to digital data transmission, but it also covers the transmission of an analog signal.

As an alternative or in addition to a data connection unit, at least one connection arrangement can advantageously have a power connection unit for power transmission. Such a power connection unit preferably has at least two electrical contacts, which could be described as “phase” and “ground”, for example. A contact at ground or reference potential can be associated with the power connection unit as well as with an additional data connection unit. However, the power transfer could also be contactless, for example inductive and/or capacitive. In this case, the power connection unit is set up for a corresponding contactless transmission.

In one embodiment, it is particularly preferred that at least one base connection arrangement has both a data connection unit and a power connection unit. The module connection arrangement of the coupled function module can also have a data connection unit and a power connection unit. However, it is also conceivable that the function module is not set up for any data transmission and accordingly only has a power connection unit. Thus, the two power connection units would be coupled in a transmitting manner, although the data connection unit of the module base is not coupled.

With regard to the functions for which the respective function module can be set up, there are basically no restrictions in the context of the disclosure. In particular, at least one function module may have an input interface and/or an output interface for a user, a read functionality for a mobile data carrier, an external interface, a charging socket and/or a wireless communication interface. The input interface can have at least one switch, button or controller, at least one sensor, which can for example be in the form of a capacitive sensor, it can have an optical sensor unit such as a camera, an acoustic sensor such as a microphone or the like. On the one hand, functions of the function module can be controlled via the input interface, and on the other hand, signals could be transmitted via data connection units to other components of the motor vehicle, which could thus be controlled by use of the function module. The output interface can be designed for optical output and can be at least one LED, a seven-segment display or a screen, for example. The screen can be in the form of a touchscreen and thus serve as an input interface at the same time. The output interface can also be set up for acoustic output, for example as a loudspeaker. A haptic output interface such as a Braille display would also be conceivable. The output interface can also be used to output information that relates only to the function module itself or information that is transmitted from other vehicle components via the transmission system and corresponding data connection units. Of course, multiple input and/or output interfaces can be combined in a function module. The read functionality for a mobile data carrier can relate to a wide variety of data carriers, for example a USB stick, a memory card, a CD but also for example a music cassette. This means that both digital and analog data can be read. The read data can be output via the function module itself or it can be transmitted via data connection units and the transmission system to other vehicle components, such as a multimedia system, via which the outputting is then carried out. It would also be conceivable that no data output would take place, but that the read data would be used within the vehicle. A function module may also have an external interface and/or a charging socket for connecting an external device, including a battery charger. The external interface could for example be a USB port or a headphone output or could be in the form of a connection for a loudspeaker, wherein a multimedia system of the motor vehicle may be connected to one or more acoustic output devices. The charging socket is used to connect an external device, which can be connected via a charging cable or directly. In particular, the charging socket can provide a DC voltage, but it can also be an AC voltage. If necessary, a rectifier, inverter or other component for adjusting the voltage can be integrated into the function module. It is understood that the function of the charging socket and the function of an external interface can be integrated into one interface, for example in a USB port. The wireless interface can be set up for different types of communication, for example Bluetooth®, WLAN, NFC or infrared. Although each function module can be connected to any module base in an ideal design, it makes sense in the sense of the disclosure if such function modules can be used in the frunk and/or trunk with which desired functions are made possible there. It is expedient to use a readout module of motor vehicle data for service purposes, or to provide connection options for external consumers and/or acoustic reproduction devices, which are connected, for example, to the multimedia system and/or the energy storage system of the motor vehicle. An external multimedia system can also be connected to the motor vehicle via a corresponding function module.

As explained above, the connection arrangements of the module base and function module do not have to match. For example, the base connection arrangement may have a power connection unit and a data connection unit, while the coupled function module has only a power connection unit. If no “active” functions are needed at a module base, on the one hand the function module could be omitted. However, the base connection arrangement would be accessible and visible from the vehicle interior. It is therefore advantageous to design at least one function module passively as a cover module to at least partially cover the base trim. The cover module can preferably be coupled in a similar way to an active function module and can be secured via the retention mechanism described. It differs from an active function module in that it does not have a module connection arrangement. The module housing of this can be very simple, as it only has the function of covering the base trim completely or partially and possibly forming a visually and/or haptically appealing surface in a certain area. A function module can also be in the form of a storage module with a partially enclosed storage space. The storage module can form a kind of box or bowl, wherein a lid can optionally be provided. In a broader sense, a holder for an external device such as a smartphone or tablet is also considered a storage module in this context. The storage module can also be of a passive form without a module connection arrangement. However, it would also be possible to integrate active functions. For example, an external interface and/or a charging socket could be integrated, to which a device accommodated in the storage module can be connected.

One design provides that at least one module base and at least one function module have mutually interacting guide structures, by use of which the function module can be moved along a guide axis on the module base to the coupling position. A guide structure can, for example, be in the form of a guide surface, guide bar, guide rail or guide groove. The guide structures of the module base on the one hand and the function module on the other are matched to each other in terms of their shape and size in such a way that they form a partial form fit, which, however, allows displacement along the guide axis. The appropriate guide makes it easier to couple the function module, which helps to ensure that even a less technically experienced user can do this. Advantageously, the module base and function module can also have mutually interacting stop structures by which the coupling position is defined. By use of a form fit, the stop structures prevent the function module from being pushed beyond the coupling position. However, such stop structures may be dispensable under certain circumstances if the retention mechanism automatically defines the coupling position, as it were.

According to one design, for example the module connection arrangement could be arranged with respect to the guide axis on the end or front side. In this case, a section of the module housing would be pushed into the coupling position at the front of the module connection arrangement, where the module connection arrangement meets the base connection arrangement that is opposite to it along the guide axis. Another advantageous design provides that at least one connection arrangement is located on a surface running parallel to the guide axis. This means that the connection arrangement is located laterally with respect to the direction of movement predefined by the guide axis. It is possible that at least parts of the corresponding connection arrangement can be elastically deflected transversely to the guide axis. This means that they can be deflected against an elastic restoring force and, in particular, at least partially recessed, either into the surrounding module housing or into the surrounding base trim. The corresponding parts of the other connection arrangement can for example define recesses running transversely to the guide axis, into which the elastically deflected parts can engage when the coupling position has been reached. Due to the elastic deflection, it can generally be achieved that a contact between the connection arrangements is secured or strengthened by an elastic restoring force. The surface on which the connection arrangement is located can be in the form of a guide surface and thus form a guide structure mentioned above.

Advantageously, the retention mechanism has an elastically deflectable latching element, which engages in a form-fitting manner in a latching recess in the locking position. The latching element can be arranged either on the function module or on the module base. Accordingly, the latching recess is arranged either on the module base or the function module. Preferably, ine one example, the latching element can be elastically deflected transversely to the guide axis. According to one embodiment, it is arranged in the area of a connection arrangement. The corresponding latching element can be used to precisely define the coupling position. On the one hand, this ensures a transmitting coupling between the connection arrangements and, on the other hand, the user receives a haptic and, if appropriate, also an acoustic signal by use of which they recognize that the coupling position has been reached. To adjust the retention mechanism from the locking position to the unlocking position and vice versa, in one design an actuation device is arranged on the function module and/or on the module base. This actuation device can be of a mechanical and/or electrical nature, for example a lever or a button, which acts on the retention mechanism, e.g., on the elastically deflectable latching element, in a blocking or releasing manner. In particular, if the latching element engages with the latching recess, it is necessary to move the latching element out of the latching recess, which is achieved with the actuation device. This actuation device can act on the elastically deflectable parts of the connection arrangements at the same time in such a way that they are also moved out of the corresponding recesses when the retention mechanism is adjusted to the release position.

One design provides that the module housing has a main section and a foot section protruding from it at an angle to the guide axis, on which the module connection arrangement is located, wherein the base trim has a retention section that forms a form fit with the foot section transverse to the guide axis. The main section is usually larger than the foot section, although these designations are not to be interpreted restrictively. A large part of the functional components of the function module can be arranged in the main section, while the foot section is wholly or mainly used to establish the connection with the base module. The base trim, for its part, has the retention section, which is shaped in such a way that it forms a form fit with the foot section, at least in the coupling position. In particular, the aforementioned guide structures may be at least partially formed on the foot section as well as on the retention section, in particular as guide surfaces. To create the form fit, for example the foot section can have an L-shaped or T-shaped cross section, with a connecting section adjacent to the main section and a flange section extending from the connecting section on one or both sides. The module connection arrangement can be arranged on the flange section. To for example interact with a T-shaped cross section, the retention section may have a C-shaped cross section at least in sections. The foot section and the retention section may also have stop structures by means of which the coupling position is defined.

Preferably, the module housing and the base trim have contact surfaces that are adjacent to each other in the coupling position. This means that the aforementioned contact surfaces are adjacent to each other and are therefore in contact with each other when the function module is in the coupling position. Thanks to the corresponding contact, the module housing and base trim are connected to each other without gaps, at least in this area, which means, for example, that protection of the connection arrangements can be improved. In addition, forces or torques acting on the function module can be transmitted to the module base via the contact surfaces, which benefits the stability of the connection. If, as mentioned above, a guide axis is defined, it would be conceivable that the contact surfaces, for example, are oriented perpendicular or parallel to the guide axis. In accordance with a preferred design, the contact surfaces run at least partially parallel to a contact plane that runs at an angle to the guide axis. According to examples, the angle between the contact plane and the guide axis can preferably be between 5° and 61°, further preferably between 10° and 40°. Due to the inclined arrangement, the contact surfaces are guided towards each other at an angle to their contact plane in relation to the guide axis when the function module is moved to the coupling position.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An interior system for a motor vehicle, the interior system comprising:
an interior structure at least partially adjacent to a vehicle interior having at least one module base;
a base trim on the at least one module base;
a base connection arrangement arranged on the base trim, wherein the base trim is associated with a transmission system of the motor vehicle;
at least one function module having a module housing;
a module connection arrangement arranged on the module housing and configured to be mechanically coupled to the at least one module base in a coupling position such that the base connection arrangement and module connection arrangement are coupled in a transmitting manner and the base trim is at least partially covered by the module housing relative to the vehicle interior; and
a retention mechanism, wherein when in a locking position, the retention mechanism prevents decoupling of the at least one function module from the at least one module base.

2. The interior system according to claim 1, wherein the at least one function module comprises a plurality of different function modules, each configured to be coupled to a module base.

3. The interior system according to claim 1, wherein the interior structure has a plurality of module bases, and wherein the at least one function module is configured to be coupled to different module bases.

4. The interior system according to claim 1, wherein at least one of the base connection arrangement and the module connection arrangement has a data connection unit for at least one of a data transmission and a power connection unit for power transmission.

5. The interior system according to claim 1, wherein the at least one function module has at least one of an input interface and an output interface for a user, a read functionality for a mobile data carrier, an external interface, a charging socket and/or a wireless communication interface.

6. The interior system according to claim 1, wherein the at least one module base and the at least one function module have mutually interacting guide structures by which the at least one function module can be moved along a guide axis to the coupling position on the module base.

7. The interior system according to claim 6, wherein at least one of the base connection arrangement and the module connection arrangement is arranged on a surface running parallel to the guide axis.

8. The interior system according to claim 7, wherein the retention mechanism has an elastically deflectable latching element, which engages in a form-fitting manner in a latching recess in the locking position.

9. The interior system according to claim 8, wherein the module housing has a main section and a foot section, on which the module connection arrangement is arranged, projecting at an angle to the guide axis, and wherein the base trim has a retention section which forms a form fit with the foot section transversely to the guide axis.

10. The interior system according to claim 9, wherein the module housing and the base trim have contact surfaces which are adjacent to each other in the coupling position and run at least partially parallel to a contact plane which runs obliquely to the guide axis.

11. An interior system for a motor vehicle, the interior system comprising:
an interior structure at least partially adjacent to a vehicle interior having a plurality of module bases;
a base trim on each of the plurality of module bases;
a base connection arrangement arranged on the base trim, wherein the base trim is associated with a transmission system of the motor vehicle;
a plurality of different function modules, each having a module housing and configured to be coupled to a module base;
a module connection arrangement arranged on the module housing and configured to be mechanically coupled to the module base in a coupling position such that the base connection arrangement and module connection arrangement are coupled in a transmitting manner and the base trim is at least partially covered by the module housing relative to the vehicle interior; and
a retention mechanism, wherein when in a locking position, the retention mechanism prevents decoupling of the function module from the module base.

12. The interior system according to claim 11, wherein at least one of the base connection arrangement and the module connection arrangement has a data connection unit for at least one of a data transmission and a power connection unit for power transmission.

13. The interior system according to claim 11, wherein the plurality of different function modules each has at least one of an input interface and an output interface for a user, a read functionality for a mobile data carrier, an external interface, a charging socket and/or a wireless communication interface.

14. The interior system according to claim 11, wherein each of the plurality of module bases and the plurality of function modules have mutually interacting guide structures by which the function module can be moved along a guide axis to the coupling position on the module base.

15. The interior system according to claim 14, wherein at least one of the base connection arrangement and the module connection arrangement is arranged on a surface running parallel to the guide axis.

16. The interior system according to claim 15, wherein the retention mechanism has an elastically deflectable latching element, which engages in a form-fitting manner in a latching recess in the locking position.

17. The interior system according to claim 16, wherein the module housing has a main section and a foot section, on which the module connection arrangement is arranged, projecting at an angle to the guide axis, and wherein the base trim has a retention section which forms a form fit with the foot section transversely to the guide axis.

18. The interior system according to claim 17, wherein each of the plurality of module housings and the plurality of base trims have contact surfaces which are adjacent to each other in the coupling position and run at least partially parallel to a contact plane which runs obliquely to the guide axis.

19. A motor vehicle comprising:
a transmission system;
a vehicle interior; and
an interior system comprising:
an interior structure at least partially adjacent to a vehicle interior having at least one module base;
a base trim on the at least one module base;
a base connection arrangement arranged on the base trim, wherein the base trim is associated with the transmission system of the motor vehicle;
at least one function module having a module housing;
a module connection arrangement arranged on the module housing and configured to be mechanically coupled to the at least one module base in a coupling position such that the base connection arrangement and module connection arrangement are coupled in a transmitting manner and the base trim is at least partially covered by the module housing relative to the vehicle interior; and
a retention mechanism, wherein when in a locking position, the retention mechanism prevents decoupling of the at least one function module from the at least one module base.

20. The interior system according to claim 19, wherein the at lease one function module comprises a plurality of different function modules, each configured to be coupled to a module base, wherein the interior structure has a plurality of module bases, and wherein the at least one function module is configured to be coupled to different module bases.
